(19) United States
(12) Patent Application Publication
(10) Pub. No.: US 2003/0058610 A1
(43) Pub. Date: Mar. 27, 2003

(54) Assembling structure of electrical appliance

(76) Inventors: Huang Chi Jui, Banchiau City (TW); Chang Ju Chin, Taoyuan City (TW)

Correspondence Address: TROJAN LAW OFFICES, 9250 WILSHIRE BLVD, SUITE 325, BEVERLY HILLS, CA, 90212

(21) Appl. No.: 09/969,426

(22) Filed: Oct. 1, 2001

(30) Foreign Application Priority Data
Jun. 13, 2001 (TW) 090209928

(51) Int. Cl. G06F 1/16

(52) U.S. Cl. 361/683

(57) ABSTRACT

An assembling structure of an electrical appliance is provided. The assembling structure includes an upper casing having at least one first engaging element disposed on an inner surface thereof, a lower casing having at least one second engaging element disposed on an inner surface thereof, wherein the at least one second engaging element is corresponding to the at least one first engaging element for engaging with the at least one first engaging element, and a connecting medium disposed between the at least one first engaging element and the inner surface of the lower casing for fastening the at least one second engaging element to the lower casing.

### FIELD OF THE INVENTION

The present invention is related to an assembling structure, and more particularly to an assembling structure of an electrical appliance.

### BACKGROUND OF THE INVENTION

Please refer to FIGS. 1 and 2. An assembling structure 10 of a personal digital assistant (PDA) includes an upper casing 11 and a lower casing 20. Four posts 21 are disposed on the lower casing 20 and typically integrally formed with the lower casing 20 in the same mold. The lower casing 20 and the upper casing 11 are coupled together through the posts 21. When the shape of the upper casing 11 is changed, the locations of the posts 21 disposed on the lower casing 20 are adjusted therewith at the same time. Consequently, the lower casing 20 be re-molded to manufacture a new lower casing in order to correspond to the changed shape of the upper casing 11 because the locations of the posts 21 disposed on the lower casing 20 fail to be adjusted directly without re-molding. Therefore, it is not convenient and inefficient that the lower casing 20 has to be re-molded to correspond to the changed shape of the upper casing 11.

It is therefore tried by the applicant to deal with the above situations encountered in the prior art.

### SUMMARY OF THE INVENTION

It is therefore an object of the present invention to provide an assembling structure of an electrical appliance, in which the assembling structure could be adjusted flexibility in response to the changed shape of the upper casing without re-molding.

It is another object of the present invention to provide the assembling structure of an electrical appliance, in which the cost of re-molding assembling structure could be highly reduced.

It is another object of the present invention to provide the assembling structure of an electrical appliance by applying a connecting medium so as to couple an upper casing with a lower casing thereof.

According to an aspect of the present invention, there is provided an assembling structure of an electrical appliance. The assembling structure includes an upper casing having at least one first engaging element disposed on an inner surface thereof, a lower casing having at least one second engaging element disposed on an inner surface thereof, wherein the at least one second engaging element is corresponding to the at least one first engaging element for engaging with the at least one first engaging element, and a connecting medium disposed between the at least one first engaging element and the inner surface of the lower casing for fastening the at least one second engaging element to the lower casing.

Preferably, the at least one first engaging element is a protrusion.

Preferably, the at least one second engaging element is a cannular sleeve for engaging with the corresponding protrusion of the upper casing.

Preferably, the lower casing and the second engaging element are made of metal material.

Preferably, the connecting medium is a solder.

Preferably, the lower casing and the second engaging element are made of plastic.

Preferably, the connecting medium is a binder.

Preferably, the electrical appliance is a personal digital assistant (PDA).

According to another aspect of the present invention, there is provided an assembling structure of a personal digital assistant (PDA). The assembling structure includes an upper casing having at least one first engaging element disposed on an inner surface thereof, a lower casing having at least one second engaging element disposed on an inner surface thereof, wherein the at least one second engaging element is corresponding to the at least one first engaging element for engaging with the at least one first engaging element, and a connecting medium disposed between the at least one first engaging element and the inner surface of the lower casing for fastening the at least one second engaging element to the lower casing.

The present invention may best be understood through the following descriptions with reference to the accompanying drawings, in which:

### BRIEF DESCRIPTION OF THE DRAWINGS

FIG. 1 is a schematic view showing an upper casing of a conventional assembling structure;

FIG. 2 is a schematic view showing a lower casing of the conventional assembling structure;

FIG. 3 is a schematic view showing a lower casing of an assembling structure according to a preferred embodiment of the present invention;

FIG. 4 is a schematic view showing the elements of the assembling structure shown in FIG. 3;

FIG. 5 is a cross-sectional view showing the assembly of the assembling structure shown in FIG. 4; and

FIG. 6 is a cross-sectional view showing the assembling structure removing the upper casing according to the preferred embodiment of the present invention.

### DETAILED DESCRIPTION OF THE PREFERRED EMBODIMENT

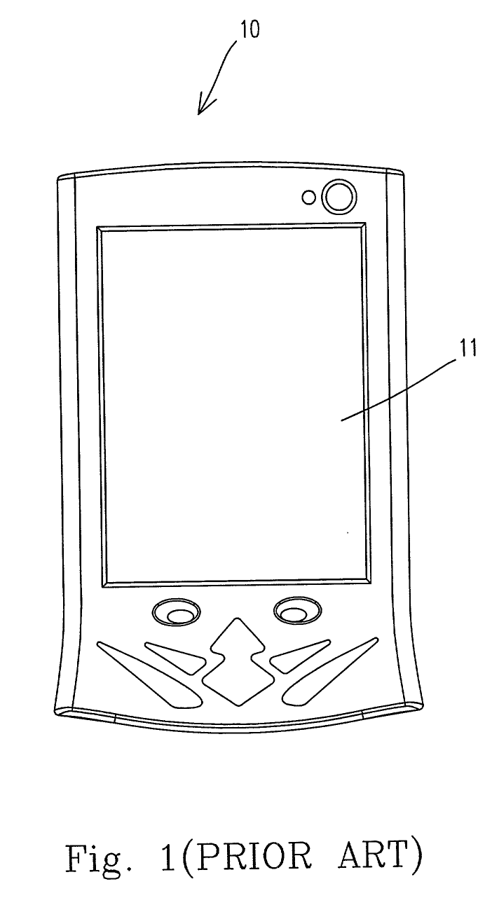

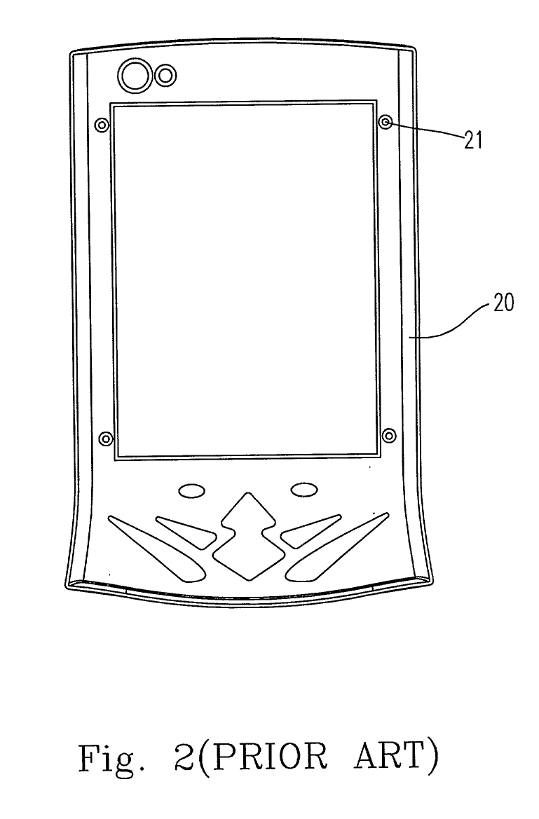

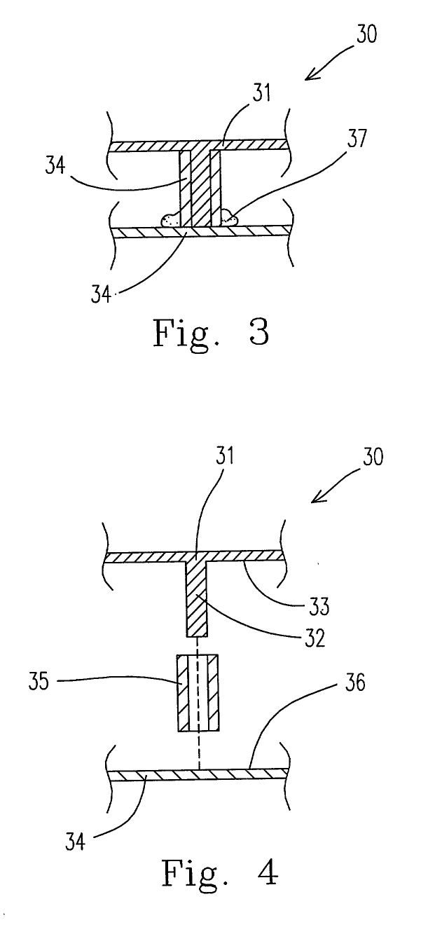

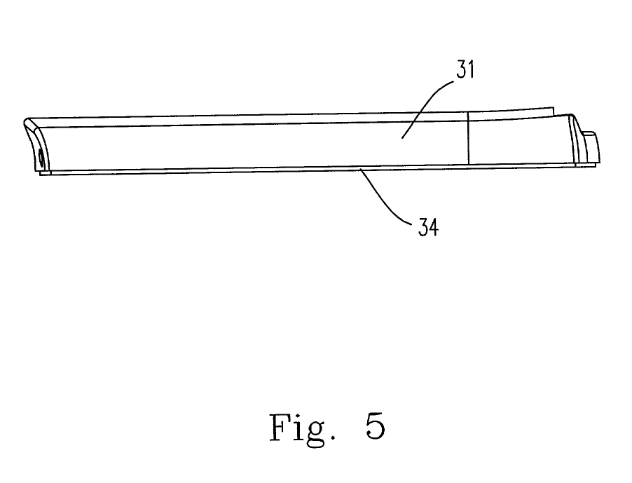

Please refer to FIGS. 3 and 4. An assembling structure 30 of electrical appliance (not shown) includes an upper casing 31, i.e. the upper casing 11 shown in FIG. 1, a lower casing 34 and a connecting medium 37. The upper casing 31 have at least one first engaging element 32 disposed on an inner surface 33 thereof and the lower casing 34 have at least one second engaging element 35 disposed on an inner surface 36 thereof. Moreover, the at least one second engaging element 35 is corresponding to the at least one first engaging element 32 for engaging with the at least one first engaging element 35, respectively. In addition, the connecting medium 37 is disposed between the at least one first engaging element 32 and the inner surface 36 of the lower casing 34 for fastening the at least one second engaging element 35 to the lower casing 34, respectively. Furthermore, the outward appearance of the assembling structure is shown in FIG. 5.

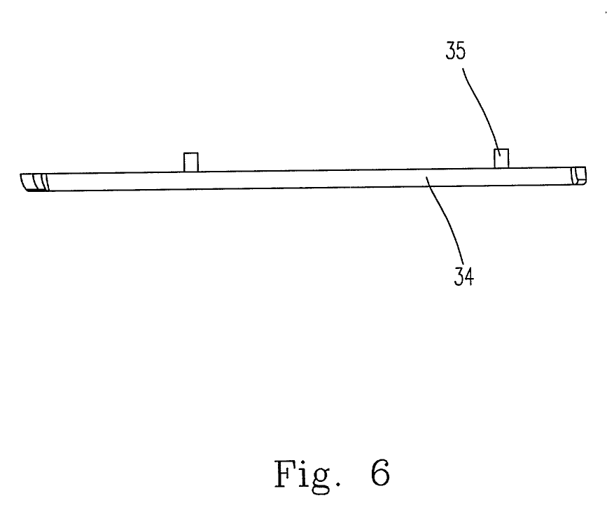

The first engaging element 32 is preferably a protrusion and the second engaging element 35 is preferably a cannular sleeve for engaging with the corresponding protrusion of the upper casing 31. In the instances described above, the lower casing 34 and the second engaging element 35 are made of metal material and the connecting medium 37 is a solder, as shown in FIG. 3. The cannular sleeve 35 is fastened through the solder, as shown in FIG. 6. Therefore, the location of the cannular sleeve 35 could be easily changed in accordance with different demands and the lower casing 34 would not be re-molded. The electrical appliance is preferably a personal digital assistant (PDA). Preferably, the lower casing 34 and the cannular sleeve 35 are made of plastic and certainly the connecting medium 37 would be a binder.

It is understood that the assembling structure according to the present invention is finished by coupling the separable engaging elements with the lower casing. The drawback of re-molding the lower casing in response to the changed shape of the upper casing in the prior art could be effectively overcome according to the present invention. The assembling structure of the present invention could be flexibly applied to different operation conditions. Therefore, the cost of manufacturing the assembling structure could be reduced.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. An assembling structure of an electrical appliance, comprising:
an upper casing having at least one first engaging element disposed on an inner surface thereof;
a lower casing having at least one second engaging element disposed on an inner surface thereof, wherein said at least one second engaging element is corresponding to said at least one first engaging element for engaging with said at least one first engaging element; and
a connecting medium disposed between said at least one first engaging element and said inner surface of said lower casing for fastening said at least one second engaging element to said lower casing.

2. The structure according to claim 1, wherein said at least one first engaging element is a protrusion.

3. The structure according to claim 2, wherein said at least one second engaging element is a cannular sleeve for engaging with said corresponding protrusion of said upper casing.

4. The structure according to claim 1, wherein said lower casing and said second engaging element are made of metal material.

5. The structure according to claim 4, wherein said connecting medium is a solder.

6. The structure according to claim 1, wherein said lower casing and said second engaging element are made of plastic.

7. The structure according to claim 6, wherein said connecting medium is a binder.

8. The structure according to claim 1, wherein said electrical appliance is a personal digital assistant (PDA).

9. An assembling structure for using the assembly of a personal digital assistant (PDA), comprising:
an upper casing having at least one first engaging element disposed on an inner surface thereof;
a lower casing having at least one second engaging element disposed on an inner surface thereof, wherein said at least one second engaging element is corresponding to said at least one first engaging element for engaging with said at least one first engaging element; and
a connecting medium disposed between said at least one first engaging element and said inner surface of said lower casing for fastening said at least one second engaging element to said lower casing.
